(19) United States
(12) Patent Application Publication
(10) Pub. No.: US 2021/0366629 A1
(43) Pub. Date: Nov. 25, 2021

(54) COMPOSITION FOR CORROSION PREVENTION

(71) Applicant: TESLA NANOCOATINGS, INC., Massillon, OH (US)

(72) Inventors: Jorma Antero VIRTANEN, Massillon, OH (US); Todd HAWKINS, Massillon, OH (US)

(21) Appl. No.: 17/394,457

(22) Filed: Aug. 5, 2021

Related U.S. Application Data
(63) Continuation-in-part of application No. 16/125,102, filed on Sep. 7, 2018.
Application No. 16/125,102 is a continuation of application No. 15/937,980, filed on Mar. 28, 2018, now Pat. No. 10,074,454.
Application No. 15/937,980 is a continuation of application No. 13/600,939, filed on Aug. 31, 2012, now Pat. No. 9,953,739.
(60) Provisional application No. 61/529,471, filed on Aug. 31, 2011.

(51) Int. Cl. H01B 1/22; C23C 30/00; C23F 11/18; C09D 163/00; H01B 1/24; C09D 5/10; C09D 5/24; C09D 5/03; C09D 101/02; C09D 197/00; C08K 3/04; C09D 7/40; C09D 7/61; C08K 3/014; B05D 5/12; C08K 3/08; C08L 97/00

(52) U.S. Cl. CPC H01B 1/22; B82Y 30/00; C23F 11/18; C09D 163/00; H01B 1/24; C09D 5/106; C09D 5/24; C09D 5/038; C09D 5/10; C09D 101/02; C09D 197/005; C08K 3/041; C09D 7/70; C09D 7/61; C08K 3/014; B05D 5/12; C08K 3/08; C09D 5/103; C08L 97/005; C23C 30/005

(57) ABSTRACT

The composition described herein for the prevention of corrosion includes sacrificial metal particles more noble than a metal substrate to which the composition contacts, carbonaceous material that can form electrical contact between the sacrificial metal particles, and means for providing an anticorrosion coating material for the metal substrate. The composition can form a coating on a metal substrate surface.

This application is a continuation-in-part of U.S. Ser. No. 16/125,201, filed Sep. 7, 2018, a continuation of U.S. Ser. No. 15/937.980 filed Mar. 18, 2018, now U.S. Pat. No. 10,074,454, which is a continuation of U.S. Ser. No. 13/600,939, filed Aug. 31, 2012, now U.S. Pat. No. 9,953,759, entitled COMPOSITION FOR CORROSION PREVENTION, which claims priority to a provisional application having U.S. Ser. No. 61/529,471, entitled COMPOSITION FOR CORROSION PREVENTION, filed Aug. 31, 2011.

### I. BACKGROUND

Described herein are compositions and methods that can prevent corrosion. More specifically, the compositions and methods described provide corrosion prevention of metal submerged in salt water and metal used in crude oil pipes.

Corrosion is the inevitable gradual destruction of material, usually metal, by chemical reaction with its environment. These metals are mainly iron and steel, although many other metals may corrode as well. This corrosion is typically due to oxidation, which can be accelerated in the presence of moisture, to form a metal oxide. Many structural alloys corrode merely from exposure to moisture in the air, but the process can be strongly affected by exposure to certain substances. For example, when iron is exposed to moist air, it reacts with oxygen to form rust, Fe₂O₃nH₂O. Coating the surface of the iron-containing article may help to shield the article from the elements needed for the natural rusting reaction to begin.

Corrosion can be concentrated locally, or it can extend across a wide area more or less uniformly corroding the surface. Because corrosion is a diffusion controlled process, it occurs on exposed surfaces. The problem with iron as well as many other metals is that the oxide formed by oxidation does not firmly adhere to the surface of the metal and flakes oft easily causing “pitting” and/or “cracking,” Extensive pitting and/or cracking may eventually cause structural weakness, a decrease in luster, a decrease of electrical conductivity, and a disintegration of the metal. Because of this structural disintegration and weakening, the effects of corrosion may cost millions of dollars each year, with much of this loss from the corrosion of iron and steel.

In mechanical terms, nanocomposites differ from conventional composite materials due to the exceptionally high surface to volume ratio of the reinforcing phase and/or its exceptionally high aspect ratio. The reinforcing material can be made up of particles (e.g. minerals), sheets (e.g. exfoliated clay stacks) or fibers (e.g. carbon nanotubes). The area of the interface between the matrix and reinforcement phase(s) is typically an order of magnitude greater than for conventional composite materials. The matrix material properties are significantly affected in the vicinity of the reinforcement. With polymer nanocomposites, properties related to local chemistry, degree of thermoset cure, polymer chain mobility, polymer chain conformation, degree of polymer chain ordering or crystallinity can all vary significantly and continuously from the interface with the reinforcement into the bulk of the matrix. This large amount of reinforcement surface area means that a relatively small amount of nanoscale reinforcement can have an observable effect on the macroscale properties of the composite. For example, adding carbon nanotubes improves the electrical and thermal conductivity. Other kinds of nanoparticulates may result in enhanced optical properties, dielectric properties, heat resistance or mechanical properties such as stiffness, strength, and resistance to wear and damage.

### II. SUMMARY

A new and improved composition for providing corrosion protection is described herein. One composition comprises: sacrificial metal particles more noble than a metal substrate to which the composition contacts; and carbonaceous material that can form electrical contact between the sacrificial metal particles; and a means for providing an anticorrosion coating material for the metal substrate.

Another aspect of the composition is to provide sacrificial metal particles that resist oxidation of iron(II) ion into iron(III) ion.

Still another aspect of the composition is to provide sacrificial metal particles that comprise at least one metal of nickel, cobalt, and/or molybdenum.

Still yet another aspect of the composition is to provide sacrificial metal particles that are microparticles or nanoparticles.

One aspect of the composition is to provide sacrificial metal particles that comprise about 0.00001% by weight to about 95% by weight of the composition.

Yet another aspect of the composition is to provide sacrificial metal particles that are regenerated.

Another aspect of the composition is to provide metal substrate that is at least one metal of iron, copper, nickel, titanium, silver, aluminum, steel, and/or stainless steel.

Still another aspect of the composition is to provide carbonaceous material that comprises graphitic carbon.

Yet another aspect of the composition is to provide graphitic carbon that comprises at least one graphitic carbon of microhorns, single-walled nanotubes, double-walled nanotubes, multi-walled nanotubes, graphite, and/or graphene.

Still yet another aspect of the composition is to provide carbonaceous material that is functionalized.

One aspect of the composition is to provide carbonaceous material that comprises about 0.1% by weight to about 20% by weight of the composition.

Another aspect of the composition is to provide carbonaceous material that comprises about 0.1% by weight to about 4% by weight of the composition.

Still another aspect of the composition is to provide a flowable material that is an anticorrosion coating material for the metal substrate.

Another aspect of the composition is to provide a flowable material comprising at least one polymer of polyacrylate, polyacrylonitrile, polybitumeate, polyethylene, polypropylene, polybutadiene, polyurea, polyamide, polyimide, polyurethane, polyvinylchloride, aspartates, fluoropolymers, silicone, siloxanes, rubber, and/or epoxy.

Yet another aspect of the composition is to provide a flowable material that is polymerized on the surface of a metal substrate.

Still yet another aspect of the composition is to provide a flowable material that is dissolved in at least one solvent. Another aspect of the composition is that the solvent is at least one solvent of dimethylformamide, dimethylsulfoxide, ethylene carbonate, acetonitrile, 2-propanol, acetone, butanone, ethyl acetate, and/or toluene.

Still another aspect of the composition is to provide a flowable material that is capable of forming a solid film or coating on the surface of the metal substrate.

Another aspect of the composition is to provide a powder coating that is an anticorrosion coating material for the metal substrate.

Still yet another aspect of the composition is to further provide the composition with cellulose.

One aspect of the composition is to provide the composition further comprising cellulose where the cellulose is functionalized cellulose and/or amorphous fragmented cellulose.

Another aspect of the composition is to further provide the composition with an antioxidant,

Another aspect of the composition is to provide antioxidants that comprise at least one antioxidant of hydrochinon, tannic acid, lignin, lignin fragments, polyunsaturated fats, esters of polyunsaturated fats, and/or pine oil.

Still another aspect of the composition is to further provide the composition with aluminum i-propoxide.

Yet another aspect of the composition is to further provide the composition with trimethyl borate.

Still yet another aspect of the composition is to further provide the composition with at least one ligand.

One aspect of the composition is to provide the ligand in which the ligand bonding comprising of at least one group of carboxylic, amino, hydroxyl amino, and/or cyano groups.

Yet another aspect of the composition is to further provide the composition with lead oxide.

Still another aspect of the composition is to further provide the composition with at least one compound of silica, alumina, titanium oxide, copper oxide, and/or tin oxide.

Still yet another aspect of the composition is to further provide the composition with at least one compound of silica, alumina, titanium oxide, copper oxide, and/or tin oxide is a microparticle or a nanoparticle.

Another aspect of the composition is to further provide the composition with sacrificial metal particles less noble than the metal substrate to which the composition contacts.

A method of protecting a metal substrate is also described herein comprising the step of applying and/or contacting the composition to a metal substrate wherein the composition comprises: sacrificial metal particles more noble than a metal substrate to which the composition contacts and carbonaceous material that can form electrical contact between the sacrificial metal particles, wherein the composition provides an anticorrosion coating material for metal.

Still another aspect of the composition is that the composition provides an anticorrosion coating material for metal comprising: a flowable material comprising epoxy functionalities; sacrificial metal particles more noble than a metal substrate to which the composition contacts comprising at least one metal of nickel and/or cobalt; carbonaceous material comprising multi-walled graphitic carbon that can form electrical contact between the sacrificial metal particles; an antioxidant comprising at least one antioxidant of hydrochinon, tannic acid, lignin, lignin fragments, polyunsaturated fats, esters of polyunsaturated fats, and/or pine oil; and means for providing an anticorrosion coating material for metal.

Still other benefits and advantages will become apparent to those skilled in the art to which it pertains upon a reading and understanding of the following detailed specification.

### III. DETAILED DESCRIPTION

Referring now to the description, wherein the descriptions may be for purposes of illustrating embodiments only and not for purposes of limiting the same, the present application may aid in illustrating the composition and method described herein.

Corrosion is the gradual destruction of material, usually metals, by chemical reaction with its environment. Described herein is a composition and a method for the prevention of corrosion, including the corrosion of iron under salt water and in crude oil pipes. By preventing or at least reducing corrosion, there can be an elimination or reduction of damage to the metal substrate.

In assessing the potential for corrosion, the type of metal may be considered. Table A (below) shows a galvanic corrosion table, which provides a comparison of different metals for galvanic corrosion according to their relative activity in seawater. Although Table A only provides a sampling of metals, it should not be considered limiting as to the type of potential metals that could be used. The anodic metals at the top of Table A are least noble, whereas the metals at the bottom of Table A are cathodic, or most noble. The further apart the metals, the higher the risk of galvanic corrosion for the metal. For the metals listed in Table A, the voltage difference between two metals can drive the current flow to accelerate corrosion of the anodic metal. The two major factors affecting the severity of galvanic corrosion are: (1) the voltage difference between the two metals on the Galvanic Series and (2) the size of the exposed area of cathodic metal relative to that of the anodic metal. Corrosion of the anodic metal is both more rapid and more damaging as the voltage difference increases and as the cathode area increases relative to the anode area.

TABLE A

| | | Approximate |
|---|---|---|
| | | Reduction Potential |
| | Material | E° (V) |
| Anodic | Potassium | −2.92 |
| (least noble) [symbol] | Sodium Magnesium Beryllium Aluminum Zinc Cadmium Titanium Cobalt Nickel Molybdenum Tin | −2.71 −2.36 −1.70 −1.66 −0.76 −0.40 −0.34 −0.28 −0.23 −0.15 −0.14 |
| Cathodic | Lead | −0.13 |
| (most noble) | Copper | +0.15 |
| | Silver | +0.80 |
| | Gold | +1.50 |

A composition described herein may provide a means for providing an anticorrosion coating material for metal. The composition may comprise carbonaceous material that can form electrical contact between sacrificial metal particles, wherein the sacrificial metal particles can be more noble than a metal substrate to which the composition contacts. Also described is a method of protecting a metal substrate using the composition described herein, which comprises sacrificial metal particles more noble than a metal substrate to which the composition may be applied, and carbonaceous material that can form electrical contact between the sacrificial metal particles.

The list in Table A represents the potential to promote a corrosive reaction; however, the actual corrosion in each application can be difficult to predict. Typically, corrosion may be reduced or eliminated through the use of certain coatings with galvanic metals that offer sacrificial anodic protection. Nevertheless, the oxidation potentials provided, as seen in Table A, are measured in water solution for bare metals. However, the oxidation potentials may change when measured in polymeric matrices; especially if the polymer or added ligand coordinates with sacrificial and protected metal differently. Within these polymeric systems used for corrosion protection, including cathodic protective coatings that may contain polymeric matrices, the actual oxidation potentials may be different than the potentials provided in Table A. in order to provide the composition described herein, the oxidation potential can be measured within the polymeric matrices in order to determine whether it is more noble than the metal to be protected.

For the composition described herein, the sacrificial metal particles more noble than a metal substrate to be protected may be dispersed within the composition. These sacrificial metal particles can resist oxidation of iron(II) ion into iron(III) which can provide protection from corrosion when they are more noble than a metal substrate to which the composition contacts. For example, these sacrificial metal particles may comprise at least one metal of nickel, cobalt, and/or molybdenum. Although the metal substrate may form a protective layer, the sacrificial metal particles more noble than a metal substrate to be protected may provide corrosion protection. For example, an iron substrate can form a hard protective layer of iron(II)oxide. The gradual slow thickening of iron(II)oxide layer may not be detrimental because an iron surface can he coated with the iron(II)oxide layer even before the composition described herein. The sacrificial metal particles more noble than a metal substrate to be protected may then prevent or at least reduce the further oxidation of iron(II)oxide into iron(III)oxide, since corrosion may only be formed when the iron(II)oxide is oxidized into iron(III)oxide. While some of these sacrificial metal particles can be oxidized, the particles may be on electric contact with the iron(II)oxide through the use of carbon nanotubes or other graphitic material where the underlying iron can be a semiconductor. The oxidation of the sacrificial metal particles more noble than a metal substrate to be protected can lead to a prevention or reduction of the sacrificial metal particles and a thickening of iron(II)oxide layer. Most notably, the formation of iron(III)oxide can be prevented or at least reduced.

In the composition, the sacrificial metal particles more noble than a metal substrate to be protected may comprise about 0.00001% by weight to about 95% by weight. The sacrificial metal particles more noble than a metal substrate can also be microparticles, which may be about 0.1 μm to about 300 μm in size. The sacrificial metal particles more noble than a metal substrate can also be nanoparticles, which may be about 1 nm and about 2500 nm in size. Where microparticles or nanoparticles are used, the composition of the sacrificial metal particles more noble than a metal substrate may be 0.00001% by weight. These sacrificial metal microparticles or nanoparticles may be easier to handle because they will not be so easily oxidized. Further, the sacrificial metal particles more noble than a metal substrate may be regenerated. Regeneration may provide a means to continuous corrosion prevention. The regeneration may be completed. by a periodic external potential. Because of the regeneration option, the composition may only require a small amount of the sacrificial metal particles more noble than a metal substrate.

The metal substrate described herein may be at least one metal of iron, copper, nickel, titanium, silver, aluminum, steel and/or stainless steel, but is not limited to those listed herein. The metal substrate may comprise a variety of shapes and sizes. The metal substrate may also be protected with other coatings for the prevention of corrosion. The metal substrate may be cleaned prior to the application of the composition described herein.

The carbonaceous material of the composition may comprise graphitic carbon. The graphitic carbon may comprise at least one graphitic carbon of microhorns, single-walled nanotubes, double-walled nanotubes, multi-walled nanotubes (also can be referred to as MWNT), graphite, and/or graphene. For example, MWNT may be used. For the composition, a relatively small amount of a carbonaceous material can allow for adequate conductivity. The carbonaceous material may comprise about 0.01% by weight to about 20% by weight of the composition. Further, the carbonaceous material may comprise about 0.1% by weight to about 4% by weight of the composition. In order to obtain increased conductivity, a higher loading level of graphitic carbon may be needed. In addition to electrical conduction, graphitic carbon may add strength of the coating. Liquid, such as salt water, can seep though cracks under the coating and corrosion will spread around cracks, which may cause the coating to gradually peel off. The use of graphitic carbon can help to diminish and/or prevent cracks, therefore reducing corrosion. Additionally, the carbonaceous material can also be functionalized.

The composition described herein may also contain flowable material. The flowable material may be liquid. The flowable material may be a plastic or a resin. The flowable material may comprise at least one polymer of polyacrylate, polyacrylonitrile, polybitumeate, polyethylene, polypropylene, polybutadiene, polyurea, polyamide, polyimide, aspartates, fluoropolymers, polyurethane, polyvinylchloride, silicone, siloxanes, rubber, and/or epoxy. During the formation of oxide from metal, the volume of the metal particle can increase; therefore, some elastic material like a polymer may be added near these particles.

The flowable material can be capable of forming a solid film or coating on the metal substrate surface. In order to prevent or reduce corrosion, flowable material can be polymerized onto the metal surface of the substrate to be protected. The flowable material may also be melted. Furthermore, the flowable material may be dissolved in at least one solvent. The solvent(s) may include at least one solvent of dimethylformamide, dimethylsulfoxide, ethylene carbonate, acetonitrile, 2-propanol, acetone, butanone, ethyl acetate, and/or toluene. The solvents listed above are not limiting, and in some cases, a wide variety of solvents may be used. However, the health and/or safety aspects of a solvent may dictate which solvents may be used. Two component or multiple component resin systems can also be used in the composition described herein. With two component polymers, no solvent may be needed when least one component is liquid. Also in such cases when polymerization is done in situ, solvent can be the monomer itself. One example of this may be with some acrylates, where the solvent can be, for example, methylmethacrylate.

Many plastics or resins may be used as a flowable material in the coating, as described above. When plastics or resins of the composition are in liquid state prior to curing, graphitic carbon like MWNT can provide an electrically conducting path. However, when these plastic or resin materials solidify, the conductivity may disappear because the material can surround the graphitic carbon, separating the graphitic carbon from each other. This can be seen with epoxies, for instance. The separation can be prevented by using cellulose, functionalized cellulose, and/or amorphous fragmented cellulose as a carrier within the composition. These materials can wrap around the MWNT and prevent them from separation during curing.

Besides using a flowable material, the composition described can be capable of forming a solid film or coating without the use of a flowable material. For example, the non-flowable composition may be a powder coating. Providing various forms of the composition described herein can after other potential applications and/or application methods for the composition.

Additionally, other additives may help to maintain electrical conductivity. Some examples can be aluminum isopropoxide and/or trimethyl borate. These additives that may help to maintain electrical conductivity can neutralize the surface charge of the MWNT so that Coulombic repulsion does not push them apart. Another additive that may be used is ligands. Ligands may also change the oxidation potentials to the extent that the galvanic order may change. if ligand binding with ion is strong, then oxidation may be facilitated. Carboxylic, amino, hydroxyl amino, and/or cyano groups can be examples of strong ligands. Thus, polyacrylic acid, polyallyl amine, amino hardened epoxy, and/or polycyano acrylate can serve as both polymeric matrix and ligands. Many of these ligands can further amplify the protecting effect of nickel and/or cobalt. Another additive, antioxidants, may also be optionally added into the composition. Nonlimiting examples of antioxidants can include hydrochinon, tannic acid, lignin and lignin fragments, polyunsaturated fatty acids and their esters, and/or pine oil. Also traditional corrosion prevention methods may be combined with the present method. For example, lead(II,II,IV)oxide may be a part of the composition. An iron plumbate layer may form on the surface of metallic iron. Iron plumbate can be hard, and further corrosion may be prevented or slowed down. The present composition can allow for a considerable reduction of lead content of the coating. The materials of the composition may be used wherever coatings will be used, including harsh applications such as marine coatings, coating of oil pipes, and/or chemical containers. In some applications, other kind of compounds such as silica, alumina, titanium oxide, copper oxide, and/or tin oxide may be added to increase hardness and/or biocidal capabilities. These compounds may be microparticles about 0.1 μm to about 300 μm in size. These compounds may also be nanoparticles about 1 nm and about 2500 nm in size. Additionally, the composition described herein may further comprise sacrificial metal particles less noble than the metal substrate to which the composition contacts. The sacrificial metal particles less noble than the metal substrate to which the composition contacts may include but is not limited to zinc, aluminum, and/or magnesium. The sacrificial metal particles less noble than a metal substrate can also be microparticles, which may be about 0.1 μm to about 300 μm in size. The sacrificial metal particles less noble than a metal substrate can also be nanoparticles about 1 nm and about 2500 nm in size. Where microparticles or nanoparticles are used, the composition of the sacrificial metal particles less noble than a metal substrate may be 0.00001% by weight. These sacrificial metal microparticles or nanoparticles less noble than a metal substrate may be easier to handle because they will not be so easily oxidized. Further, the sacrificial metal particles less noble than a metal substrate may be regenerated.

Also described is the method of protecting a metal substrate using a composition comprising sacrificial metal particles more noble than a metal substrate to which the composition contacts and carbonaceous material that can form electrical contact between the sacrificial metal particles. Within the method, the composition described herein can be applied to a metal substrate in order to protect it from corrosion. The composition may be a flowable material or a powder coating. The method may be used separately or in addition to other method(s) that may be used for corrosion protection. The method may also be repeated at least once. The method may also be used to prevent or reduce further corrosion that may have already occurred on a metal substrate.

The composition is designed or constructed to be used to prevent oxidation of the layer of iron (II) oxide on the associated metal substrate from an iron (II) to an iron (III). The polymeric matrix binds individual metal atoms or ions, and facilitates oxidation, which oxidizes the sacrificial metal instead of the substrate. The composition allows oxidation of the metal particles to prevent oxidation of the substrate. While all other anticorrosion methods (for steel) focus on preventing the oxidation of metallic iron, this method allows, and even favors the oxidation of iron to iron (II) oxide, but prevents the further oxidation to iron(III), i.e., prevent the formation of a red rust.

In one aspect of the present teaching, the sacrificial metal particles are not coated with a mono layer, which passivates the particles. In one aspect of the present teaching, the sacrificial metal particles are not passivated. Coating facilitates dispersion, which aids in making a nanocomposite. The present composition is making a composite, or mixture, and not a nanocomposite. In another aspect of the present teaching, the composition excludes lithium salts.

The embodiments have been described, hereinabove. It will be apparent to those skilled in the art that the above composition and method may incorporate changes and modifications without departing from the general scope. It is intended to include all such modifications and alterations in so far as they come within the scope of the appended claims or the equivalents thereof.

Having thus described the composition and method, it is now claimed:

What is claimed is:

1. A corrosion prevention composition comprising:
sacrificial metal particles, wherein the sacrificial metal particles comprise at least one metal of nickel, molybdenum, or cobalt, wherein the sacrificial metal particles are not passivated;
a polymeric matrix, wherein the polymeric matrix comprises at least one amino hardened epoxy; and
carbonaceous material that forms electrical contact between the sacrificial metal particles, wherein the composition is adapted to form a layer on top of a layer of iron (II) oxide on an associated metal substrate comprising iron and is adapted to prevent oxidation of the layer of iron (II) on the associated metal substrate from an iron (II) to an iron (III), and wherein the sacrificial metal particles have a higher reduction potential than the associated metal substrate; and
a flowabie material.

2. The composition of claim 1, wherein the sacrificial metal particles are microparticles or nanoparticles, wherein the sacrificial metal particles comprise 0.00001% by weight to about 95% by weight of the composition, wherein the carbonaceous material comprises graphitic carbon, wherein the graphitic carbon comprises at least one graphitic carbon of microhorns, nanotubes, double-walled nanotubes, multi-walled nanotubes, graphite, and graphene.

3. The composition of claim 1, wherein the composition has no lithium salts.

4. The composition of claim 1, wherein the carbonaceous material is functionalized, wherein the carbonaceous material comprises about 0.1% by weight to about 20% by weight of the composition.

5. The composition of claim 1, wherein the composition is not a nanocomposite.

6. The composition of claim 1, wherein the flowable material comprises at least one polymer of polyacrylate, polyacrylonitrile, polybitumeate, polyethylene, polypropylene, polybutadiene, polyurea, polyamide, polyimide, polyurethane, polyvinylchloride, aspartates, fluoropolymers, silicone, siloxanes, rubber, and epoxy.

7. The composition of claim 1, wherein the composition further comprises cellulose, wherein the cellulose comprises at least one cellulose of functionalized cellulose and amorphous fragmented cellulose.

8. The composition of claim 1, wherein the composition further comprises an antioxidant, wherein the antioxidant comprises at least one antioxidant of hydrochinon, tannic acid, lignin, lignin fragments, polyunsaturated fats, esters of polyunsaturated fats, and pine oil.

9. The composition of claim 8, wherein the composition further comprises aluminum i-propoxide.

10. The composition of claim 1, wherein the composition further comprises trimethyl borate.

11. The composition of claim 1, wherein the composition further comprises lead oxide.

12. The composition of claim 1, wherein the composition further comprises at least one compound of silica, alumina, titanium oxide, copper oxide, and tin oxide.

13. The composition of claim 1, wherein the composition further comprises a second set of sacrificial metal particles, wherein the second set of sacrificial metal particles have a lower reduction potential than the associated metal substrate, wherein the second set of sacrificial metal particles having a lower reduction potential than the associated metal substrate are at least one of zinc, aluminum, and magnesium.

14. A corrosion prevention composition comprising:
sacrificial metal particles, the sacrificial metal particles comprising at least one metal of nickel and cobalt;
carbonaceous material comprising multi-walled graphitic carbon that can form electrical contact between the sacrificial metal particles;
a flowable material comprising epoxy functionalities; and
an antioxidant comprising at least one antioxidant of hydrochinon, tannic acid, lignin, lignin fragments, polyunsaturated fats, esters of polyunsaturated fats, and pine oil, wherein the composition is adapted to form a layer on top of a layer of iron (II) oxide on an associated metal substrate comprising iron and the composition is adapted to prevent oxidation of the layer of iron (II) oxide on the associated metal substrate from an iron (II) to an iron (III), wherein the composition has no lithium salts.

15. A corrosion prevention composition comprising:
sacrificial metal particles, wherein the sacrificial metal particles are molybdenum, wherein the sacrificial metal particles are not passivated;
carbonaceous material that forms electrical contact between the sacrificial metal particles;
a polymeric matrix, wherein the polymeric matrix comprises at least one amino hardened epoxy; and
wherein the composition is adapted to form a layer on top of a layer of iron (II) oxide on an associated metal substrate comprising iron and the composition is adapted to prevent oxidation of the layer of iron (II) oxide on the associated metal substrate from an iron (II) to an iron (III), and wherein the sacrificial metal particles have a higher reduction potential than the associated metal substrate.

16. The composition of claim 15, wherein the sacrificial metal particles comprise 0.00001% by weight to about 95% by weight of said composition, wherein the carbonaceous material comprises graphitic carbon, wherein said graphitic carbon comprises at least one graphitic carbon of microhorns, single-walled nanotubes, double-walled nanotubes, multi walled nanotubes, graphite, and graphene.

17. The composition of claim 15, wherein the composition contains no lithium salts.

18. The composition of claim 15, wherein the polymeric matrix is a flowable material, wherein the flowable material comprises at least one polymer of polyacrylate, polyacrylonitrile, polybitumeate, polyethylene, polypropylene, polybutadiene, polyurea, polyimide, polyitnide, polyurethane, polyvinylchlotide, aspartates, fluoropolymers, silicone, siloxanes, rubber, and epoxy.

19. The composition of claim 15, wherein the composition further comprises cellulose, wherein the cellulose comprises at least one cellulose of functionalized cellulose and amorphous fragmented cellulose.

20. The composition of claim 15, wherein the composition further comprises an antioxidant, wherein the antioxidant comprises at least one antioxidant of hydrochinon, tannic acid, lignin, lignin fragments, polyunsaturated fats, esters of polyunsaturated fats, and pine oil.
